(19) United States
(12) Patent Application Publication
(10) Pub. No.: US 2015/0081375 A1
(43) Pub. Date: Mar. 19, 2015

(54) VISUAL SCHEDULING TOOL FOR OPTIMIZING CAPACITY UTILIZATION

(71) Applicant: Ormco Corporation, Orange, CA (US)

(72) Inventors: Paul D. SLOUP, Irvine, CA (US); Jeannette M. HICKS, Grants Pass, OR (US); Troy D. GRISSEN, Broken Arrow, OK (US)

(21) Appl. No.: 14/028,418

(22) Filed: Sep. 16, 2013

(51) Int. Cl. G06Q 90/00; G06Q 10/06; G09F 11/02

(52) U.S. Cl. CPC G06Q 90/00; G09F 11/02; G06Q 10/06315
USPC 705/7.25; 40/495; 705/500

(57) ABSTRACT

One or more regions in a first element that is fixed correspond to indications of a likelihood of satisfying customer demand while optimizing capacity utilization. Customer requirements are stored in a second element that is movable, wherein the one or more regions in the first element are interpreted to determine the likelihood of satisfying customer demand while optimizing capacity utilization, based on the stored customer requirements.

### FIELD

The disclosure relates to a visual scheduling tool for optimizing capacity utilization, for displaying the likelihood of satisfying customer demand, and for capacity and resource planning in a manufacturing environment.

### BACKGROUND

A Heijunka box is a visual scheduling tool that may be used in Heijunka, where Heijunka is a mechanism to achieve a smoother flow of production of parts. While Heijunka refers to the mechanism for achieving production smoothing, the Heijunka box is the name of a specific tool used in achieving the goals of Heijunka.

The Heijunka box may comprise a schedule that may be divided into a grid of boxes (or a set of pigeon-holes or rectangular receptacles). Each column of boxes may represent a specific period of time, and lines may he drawn down the schedule to visually break the schedule into columns of individual shifts or days or weeks. Cards representing individual jobs (referred to as Kanban cards) may be placed on the Heijunka box to provide a visual representation of upcoming production runs.

The Heijunka box may make it easy for operators to see what type of jobs are queued for production and for when such jobs are scheduled. Workers on the factory floor may remove the Kanban cards for the current period from the box in order to determine what tasks to perform.

### SUMMARY OF THE PREFERRED EMBODIMENTS

Provided are an apparatus, a method, a computational system, and a computer readable storage medium in which one or more regions in a first element that is fixed correspond to indications of a likelihood of satisfying customer demand while optimizing capacity utilization. Customer requirements are stored in a second element that is movable, wherein the one or more regions in the first element are interpreted to determine the likelihood of satisfying customer demand while optimizing capacity utilization, based on the stored customer requirements.

In certain embodiments, the customer requirements are included in one or more cards that include order information, wherein the one or more cards are placed in, or removed from locations in the second element.

In additional embodiments, the first element is an inner wheel that cannot be rotated, and the second element is an outer wheel that is rotated, in response to a selected location in the second element being emptied of cards.

In further embodiments, the one or more regions in the first element are color coded to provide indications of inventory states.

In yet further embodiments, a first color coding indicates that there is insufficient inventory, and a second color coding indicates that there is excessive inventory.

In still further embodiments, a third color coding indicates that inventory and customer demand are in balance.

In additional embodiments, the first element and the second element together comprise a visual scheduling tool.

In yet additional embodiments, the first element and the second element are coupled mechanically, wherein the first element is physically rotated by an operator.

In certain embodiments, a planning chart is used to generate a mapping of cards of the second element to the indications of the likelihood of satisfying customer demand of the first element.

### BRIEF DESCRIPTION OF THE DRAWINGS

Referring now to the drawings in which like reference numbers represent corresponding parts throughout:

FIG. 1 illustrates a block diagram of a system that includes a scheduling wheel that is used for optimizing capacity utilization based on customer demand, in accordance with certain embodiments;

FIG. 2 illustrates a diagram of a scheduling wheel, in accordance with certain embodiments;

FIG. 3 illustrates a diagram that shows how cur s are placed in the scheduling wheel, in accordance with certain embodiments;

FIG. 4 illustrates a block diagram of an exemplary card, in accordance with certain embodiments;

FIG. 5 illustrates a block diagram that shows a mapping of color coded regions of the inner wheel to inventory states, in accordance with certain embodiments;

FIG. 6 illustrates a flowchart that shows operations performed with respect to the scheduling wheel, in accordance with certain embodiments;

FIG. 7 illustrates a scheduling wheel with an excessive inventory scenario, in accordance with certain embodiments;

FIG. 8 illustrates a scheduling wheel with an insufficient inventory scenario, in accordance with certain embodiments;

FIG. 9 illustrates a scheduling wheel with the inventory in balance with customer demand, in accordance with certain embodiments;

FIG. 10 illustrates a scheduling wheel implemented as a mechanical device in accordance with certain embodiments;

FIG. 11 illustrates a scheduling wheel implemented in another mechanical device, in accordance with certain embodiments;

FIG. 12 illustrates a scheduling wheel implemented in a computational device, in accordance with certain embodiments;

FIG. 13 illustrates a mechanism over which the scheduling wheel is an improvement, in accordance with certain embodiments;

FIG. 14 illustrates an apparatus, in accordance with certain embodiments;

FIG. 15 illustrates a flowchart, in accordance with certain embodiments; and

FIG. 16 illustrates a system corresponding to a computational device that implements the scheduling wheel, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Certain embodiments provide a visual scheduling tool for optimizing capacity utilization. Certain embodiments display the likelihood of satisfying customer demand to an operator, such that the operator may take remedial action to speed up or slow down, or to maintain the rate of batch manufacturing of parts in a batch manufacturing environment. Certain embodiments maximize profitability while satisfying customer demand within the promised lead time. Overburdening and unevenness is reduced in the manufacturing environment.

### Exemplary Embodiments

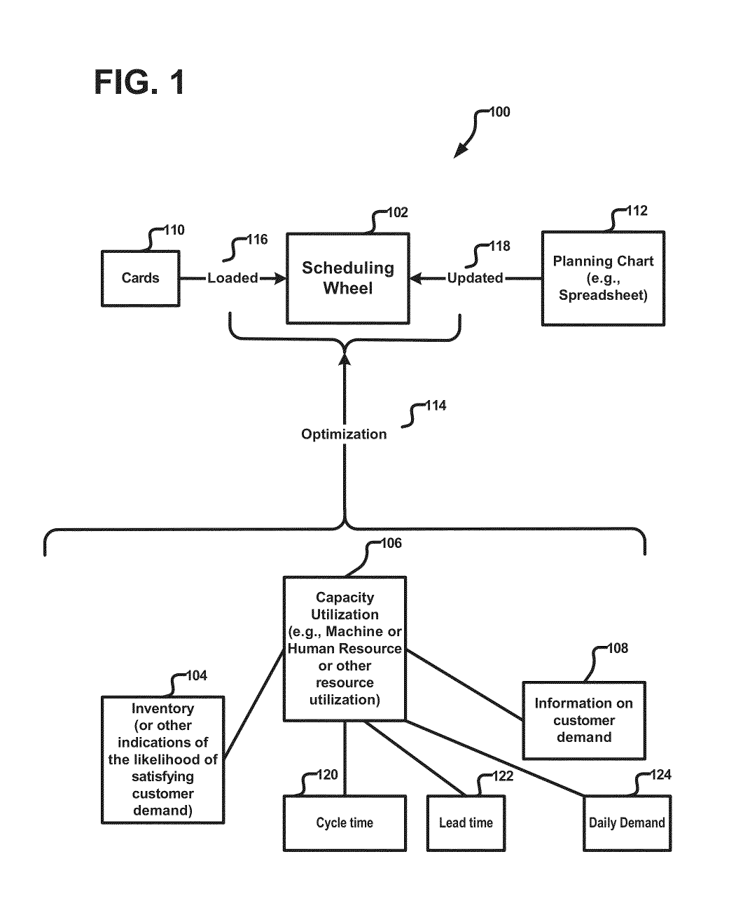

FIG. 1 illustrates a block diagram 100 of a system that includes a scheduling wheel 102 that is used for optimizing capacity utilization 106 based on various factors such as inventory 104 and information on customer demand 108, in accordance with certain embodiments. In certain embodiments, inventory may or may not be maintained and satisfaction of customer demand 108 within a promised lead time while maximizing profitability may be achieved. The scheduling wheel 102 may be used to determine how to utilize a machine for producing parts in a batch production environment. For example, the scheduling wheel 102 may indicate that the inventory 104 of parts is inadequate and the machine may be operated with greater resources or personnel to produce parts for a customer, or the scheduling wheel 102 may indicate that the inventory 104 of parts is more than adequate and the machine may be idled.

The inventory 104 refers to the amount or number of parts or material that is already available for shipment to customers. The capacity utilization 106 refers to the number of parts or amount of material per unit time that the machine is producing. For example, the machine may have a capacity to produce 5 parts per hour. The information on customer demand 108 may include information such as the promised lead time to the customer, the customer demand, etc.

The scheduling wheel 102 is loaded with cards 110 that comprise customer requirements. For example, an exemplary card may indicate that production of ten parts is needed. The cards 110 are loaded to the scheduling wheel 102 based on customer orders that arrive.

A planning chart 112 that may comprise a spreadsheet may be used to configure the scheduling wheel 102, before the scheduling wheel 102 is used for managing inventory for a machine in a batch production environment. The configuration of the scheduling wheel 102 may be based on the cycle time 120, the lead time 122, and the daily demand 124 that may be used to optimize the capacity utilization 106.

Therefore, FIG. 1 illustrates certain embodiments in which a scheduling wheel 102 performs a optimization (reference numeral 114) of capacity utilization 106 based on factors such as inventory 104 and information on customer demand 108. Cards 110 that include customer orders are loaded (reference numeral 116) to a scheduling wheel 102 that may be periodically configured via the output of a planning chart 112.

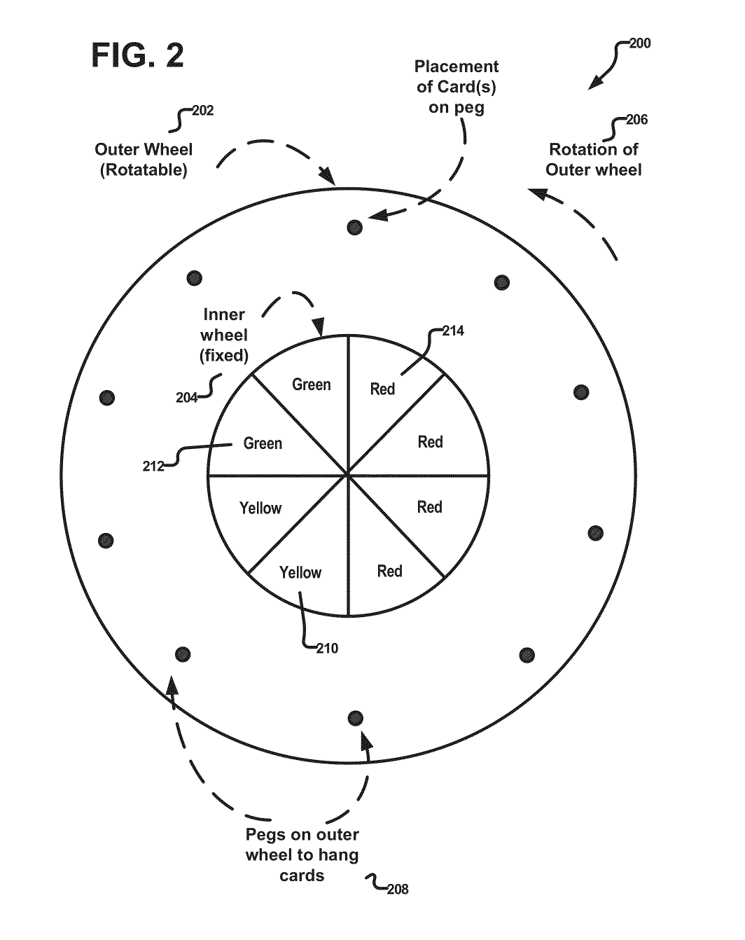

FIG. 2 illustrates a diagram of a scheduling wheel 200, in accordance with certain embodiments. The scheduling wheel 200 is comprised of an outer wheel 202 that is rotatable (i.e., can be rotated) and an inner wheel 204 that is fixed. The outer wheel 202 is shown as being rotatable (reference numeral 206) in an anticlockwise direction. In alternative embodiments, the outer wheel 202 is rotatable in a clockwise direction or in both clockwise and anticlockwise directions. In certain embodiments in which the outer wheel 202 is rotatable in both clockwise and anticlockwise direction, an operator or a computer program rotates the outer wheel along one direction (i.e., either in an anticlockwise or in a clockwise direction), and rotations are not performed in the other direction.

The outer wheel 202 has a plurality of pegs towards the periphery of the outer wheel, and certain exemplary pegs are shown via reference numeral 208. The number of pegs may be different in different embodiments. The pegs are used to hang cards that include customer requirements, such as customer orders. In alternative embodiments mechanisms that are different from pegs may be used to couple or associate work orders to the mechanisms.

In certain embodiments, the inner wheel 204 is fixed and regions of the inner wheel are color coded. Exemplary color codings of the inner wheel into yellow, green, and red regions are shown. For example region 210 is colored yellow, region 212 is colored green, and region 214 is colored red. Instead of color other mechanisms, such as shading, numbering, or textual indications, may be used to indicate different regions of the inner wheel 204.

The inner wheel 204 and the outer wheel 202 are both disc shaped and may be constructed from plastic, paper'board, or any other type of material. In alternative embodiments, the inner wheel 204 and the outer wheel 202 may be shaped differently.

Therefore, FIG. 2 illustrates certain embodiments in which customer orders that arrive are hung on pegs of a rotatable outer wheel 202 that rotates around a fixed inner wheel 204 that has color coded regions. The outer wheel 202 and the inner wheel 204 together comprise the scheduling wheel 200.

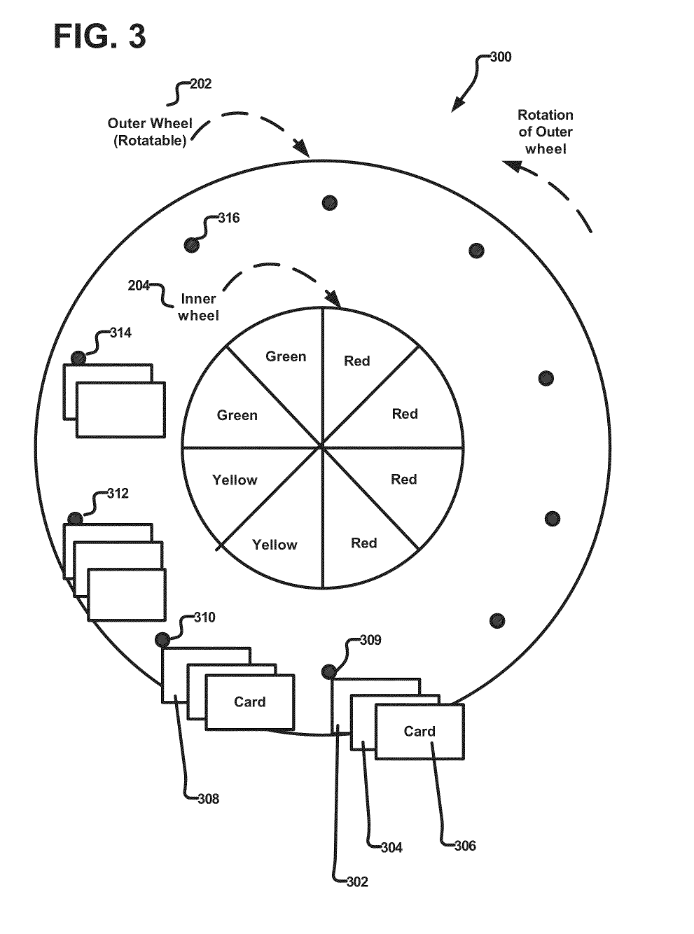

FIG. 3 illustrates a diagram 300 of the scheduling wheel 200 that shows how cards (e.g., 302, 304, 306 308) are placed in the pegs of the outer wheel 202, in accordance with certain embodiments.

Each card corresponds to a batch of parts that are to be produced in a batch production environment. In a batch production environment the time taken for each hatch of parts to be produced is substantially the same. For example, if a batch can produce a maximum of 100 parts then whether the card indicates that 2 parts are to be produced or 75 parts are to be produced the time taken is substantially the same.

As cards with order requirements arrive, the cards are first placed on peg 309 that may be referred to as the reference peg. Each peg has a maximum number of cards that may be hung on the peg. In FIG. 3, each peg can accommodate three cards at most. So after peg 309 is full, the operator starts hanging cards on peg 310, and then on peg 312, and then on peg 314. It is seen that peg 314 has only two cards, so when the next card is to be placed it is placed on peg 314. Peg 316 does not have any cards.

The operator removes the card 306 from peg 309 to produce a batch of parts in a machine. Then he removes the card 304 to produce the next batch of parts, and then he removes card 302 to produce the next batch of parts. The cards from the peg 309 may be removed in any order. Once cards 306, 304, 302 are removed from peg 309, the peg 309 is empty and the outer wheel is rotated anticlockwise so that peg 310 occupies the position that was previously occupied by peg 309, i.e., peg 310 is now the new reference peg and cards are removed from peg 310.

It should be noted that the operator places cards in pegs in a clockwise direction and after each peg is full proceeds to the next peg. Cards are always removed only from the reference peg, and after the reference peg is empty the outer wheel 202 is rotated in an anticlockwise direction to make the next peg the reference peg.

In certain alternative embodiments, the total amount of time spent to fulfil requirements indicated on the cards placed on each peg is the same. For example in certain embodiments, a first peg may have two cards each of which takes three hours, whereas a second peg may have three cards each of which takes two hours, and a third peg may have two cards in which the first card takes one hour and the second card takes five hours. In such embodiments, each peg corresponds to six hours.

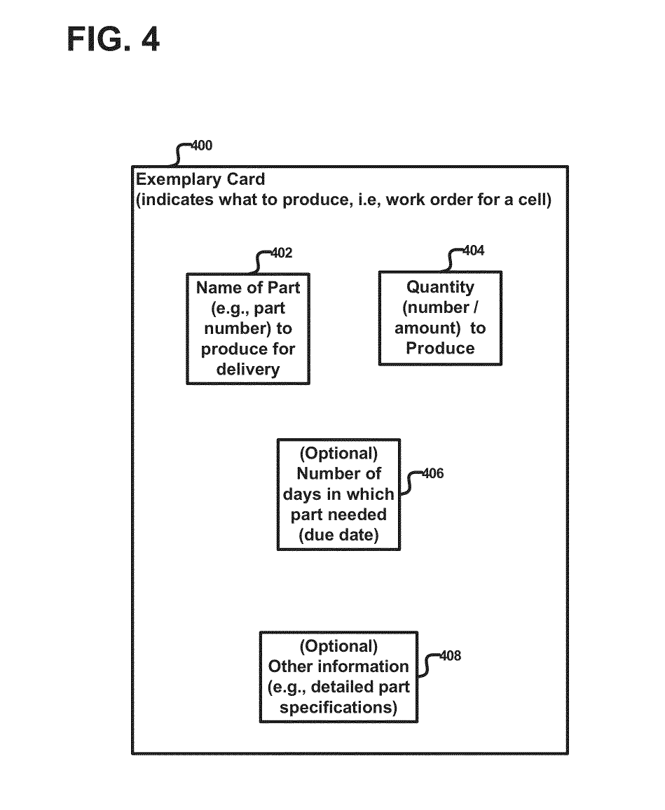

FIG. 4 illustrates a block diagram of an exemplary card 400, in accordance with certain embodiments. The exemplary card 400 indicates what to produce in a batch production environment. The exemplary card may indicate the name of the part to produce for delivery (reference numeral 402) and the quantity (i.e., the number or amount shown via reference numeral 404) to produce.

The exemplary card 400 may also have optional indicators that show the number of days in which the part is needed by the customer (shown via reference numeral 406) and other information 408, such as detailed part specifications.

The exemplary card 400 may be generated by planning personnel or a computer program, based on customer orders that may be received by a manufacturer. An operator of the scheduling wheel places the exemplary card 400 on a peg of the outer wheel.

When the exemplary card 400 is removed from the peg, after the peg has become the reference peg, the operator produces the quantity of parts in a single batch based on the information included in indicators 402, 404.

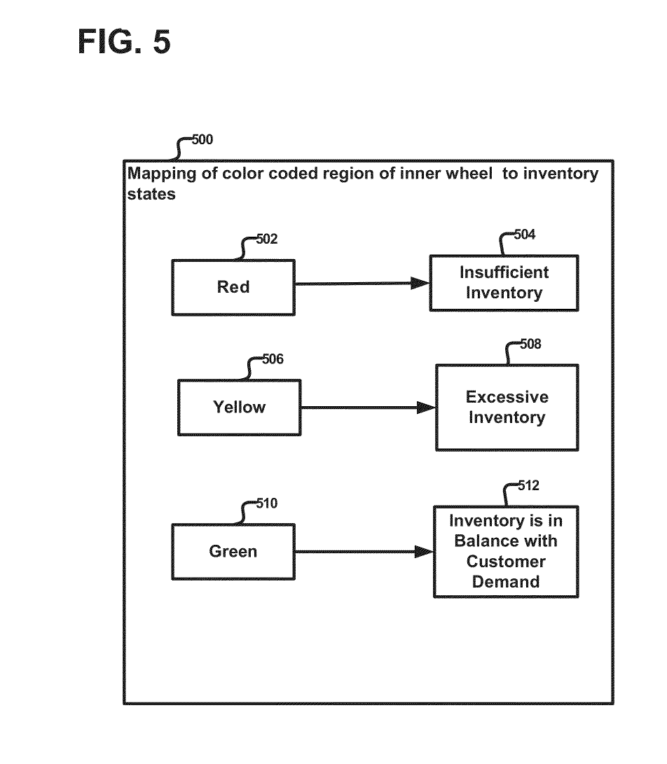

FIG. 5 illustrates a block diagram 500 that shows a mapping of color coded regions of the inner wheel to inventory states, in accordance with certain embodiments.

The color coded regions of the inner wheel is used to determine whether the inventory of parts is insufficient, excessive or in balance with customer demand. For example, in certain embodiments, the color coding of red 502 indicates that there is insufficient inventory 504 and operators are to remove cards from pegs and start the batch manufacturing production and possibly accelerate such production by employing more resources or personnel. The color coding of 506 may indicate that there is excessive inventory 508 and the batch production process may be idled to allow customer orders to arrive. If the color coding is green 510 it may indicate that the inventory is in balance with customer demand.

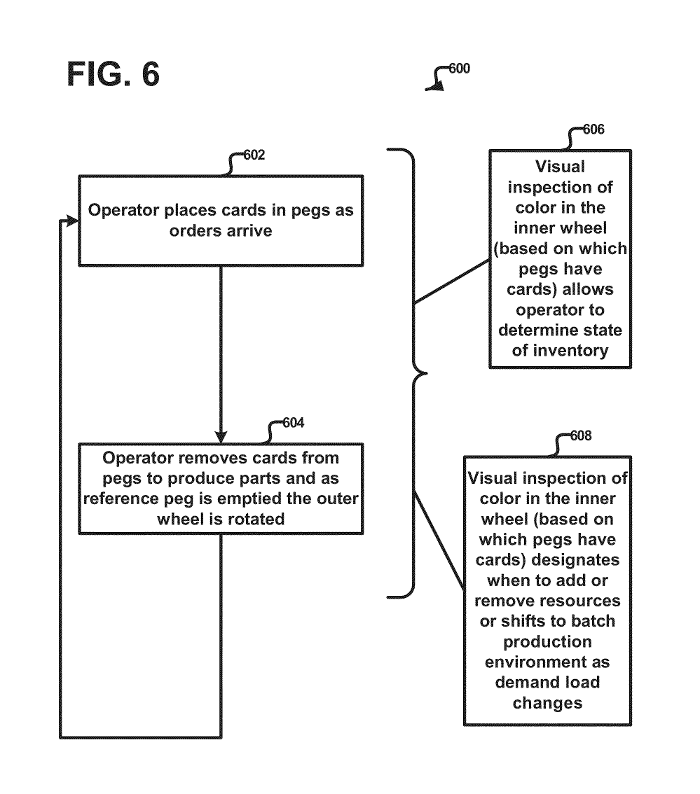

FIG. 6 illustrates a flowchart 600 that shows operations performed with respect to the scheduling wheel (such as scheduling wheel 102, 200), in accordance with certain embodiments.

At block 602, the operator places cards in the pegs of the outer wheel as orders arrive. At block 604 the operator removes cards from pegs to produce parts, and as the reference peg is emptied the outer wheel is rotated.

The visual inspection of the color in the inner wheel based on which pegs have cards allows the operator to determine the state of the inventory and to determinate when to add or remove resources or shifts to the batch production environment as the demand load changes (shown via reference numeral 606, 608).

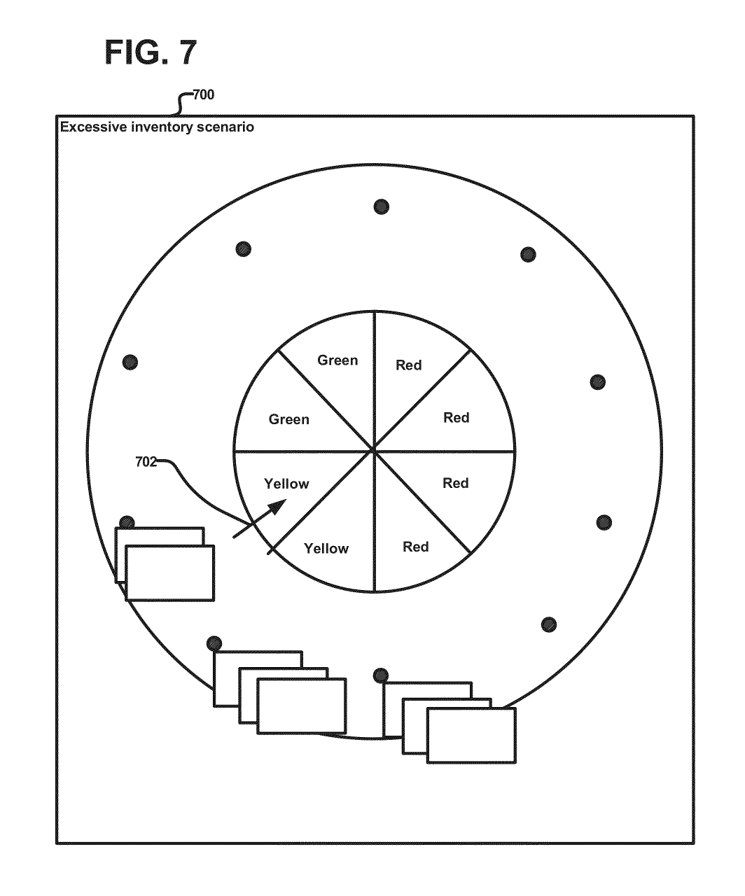

FIG. 7 illustrates a scheduling wheel 700 with an excessive inventory scenario, in accordance with certain embodiments. In FIG. 7 cards have been placed on the pegs of the outer wheel till the yellow region (as indicated by the arrow 702) of the inner wheel, and therefore there is excessive inventory. The batch production environment may be idled or resources or shifts may be reduced in the batch production environment for order flow to catch up.

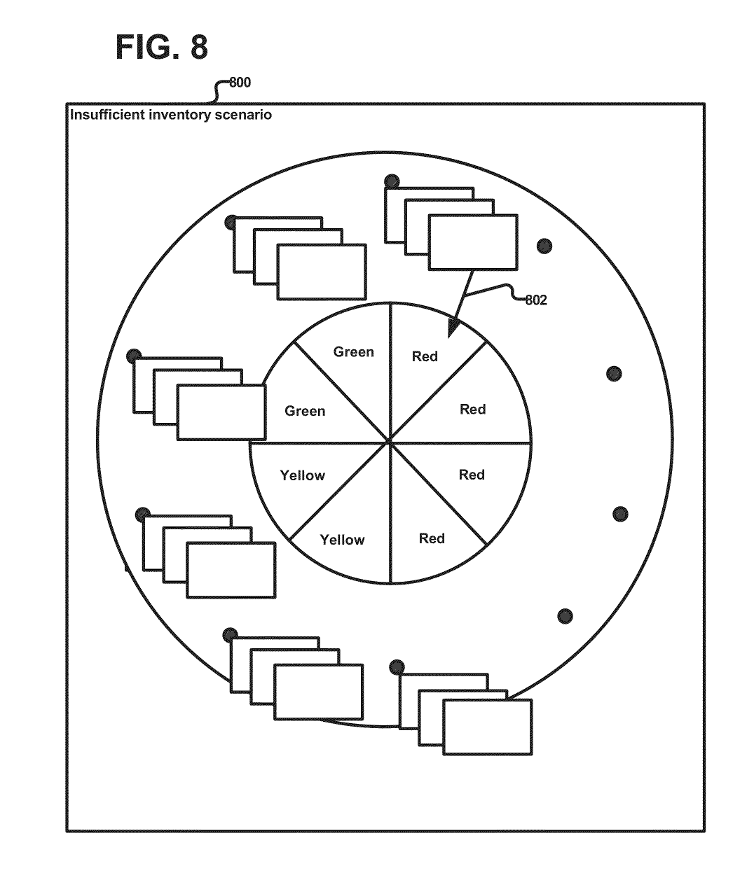

FIG. 8 illustrates a scheduling wheel 800 with an insufficient inventory scenario, in accordance with certain embodiments. In FIG. 8 cards have been placed on the pegs of the outer wheel till the red region as indicated by the arrow 802) of the inner wheel, and therefore there is insufficient inventory. Too many orders are pending, and therefore resources or shifts may be increased in the batch production environment for part manufacturing to catch up with order flow.

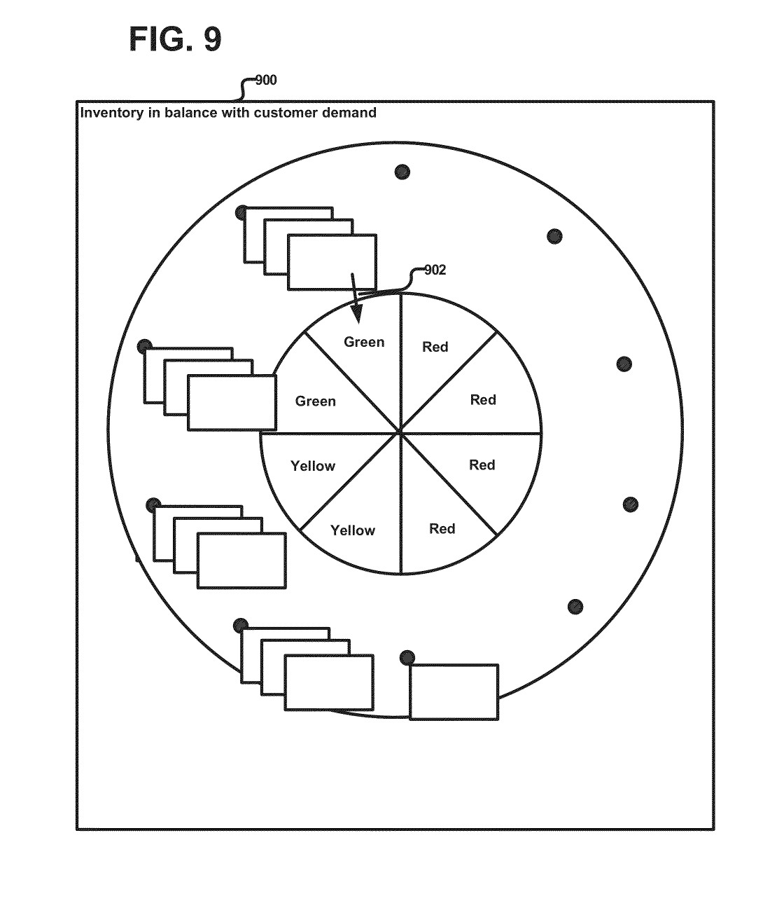

FIG. 9 illustrates a scheduling wheel 900 with the inventory in balance with customer demand, in accordance with certain embodiments. In FIG. 9 cards have been placed on the pegs of the outer wheel till the green region as indicated by the arrow 902) of the inner wheel, and therefore there inventory is in balance with customer orders. Therefore resources or shifts may be remain unchanged in the batch production environment.

Therefore FIGS. 7, 8, 9 illustrate certain embodiments in which by visual inspection of the scheduling wheel an operator may determine the state of inventory in the batch production environment and take appropriate action. It should noted that inventory is just an example, and the embodiments attempt to optimize capacity utilization while maximizing profitability and satisfy customer demand within a promised lead time. In certain embodiments, no inventory may be maintained.

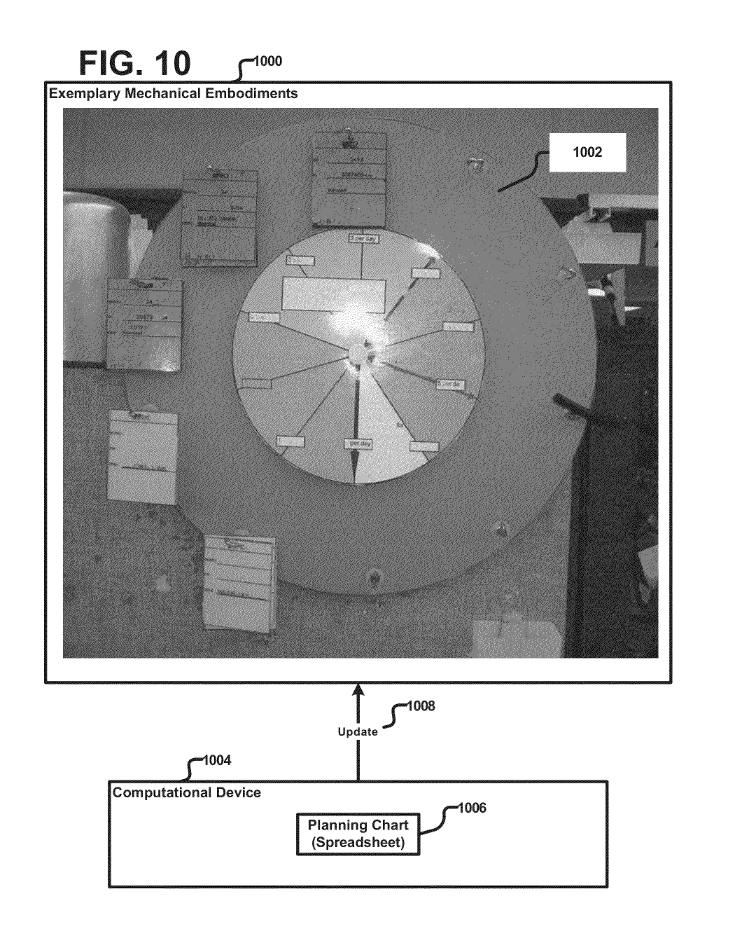

FIG. 10 illustrates a block diagram 1000 in which a scheduling wheel is implemented as a mechanical device 1002, in accordance with certain embodiments. A computational device 1004 with a spreadsheet 1006 (a planning chart) may be used to update (reference numeral 1008) and design the scheduling wheel 1002 implemented as the mechanical device 1002. The design of the scheduling wheel 1002 bay be based on the daily demand, the lead time, and the cycle time. The cycle time is the production time and is a subset of the lead time, where the lead time is the time from receipt of a customer order to the time at which the order can be delivered to the customer. The cycle time assumes that if all resources are available then how much time is taken to produce a part, i.e., cycle time is analogous to production time. The lead time is the time promised to the customer for delivery of an order.

The design of the scheduling wheel can easily accommodate demand variations of 50%. However if there is an excessive demand change (e.g., a 300% demand change) then the scheduling wheel may have to be redesigned. The demand may be a projected demand based on prior historical pattern of demand or may be based on marketing analysis of projected future sales in the event of introduction of a new product.

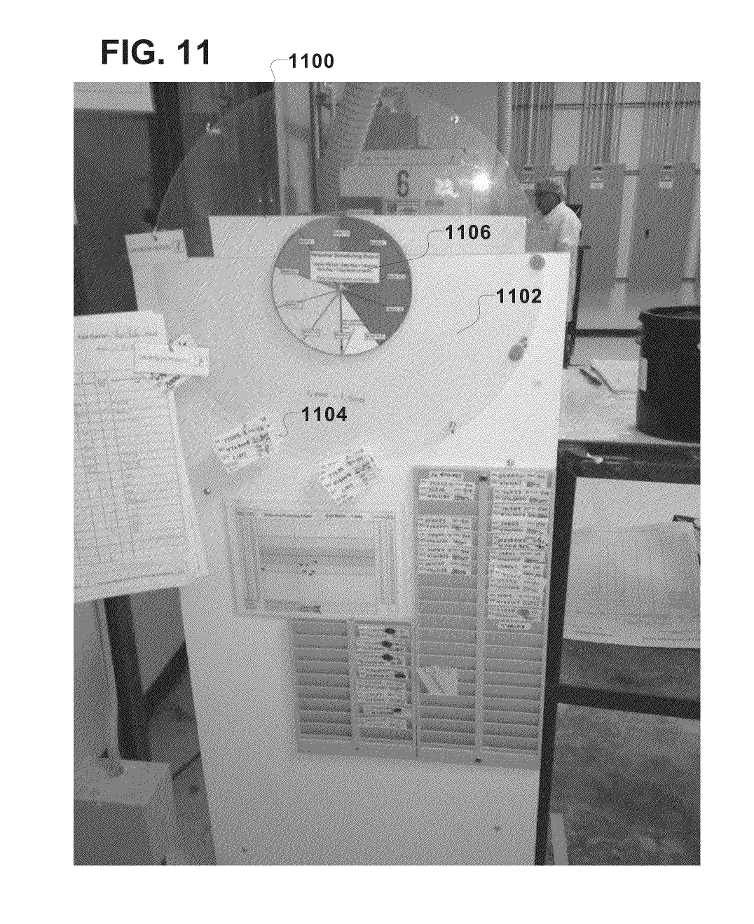

FIG. 11 illustrates a block diagram 1100 of a scheduling wheel 1102 implemented as a mechanical device, in accordance with certain embodiments. Exemplary cards 1104 are shown to be placed on the pegs of the scheduling wheel. Various information related to the scheduling wheel may be written on the center of the inner wheel for the convenience of the operator. Such information may include information such as the daily rate of batch manufacturing, how many cards are to be placed on each peg, how many days of build each peg corresponds to, etc.

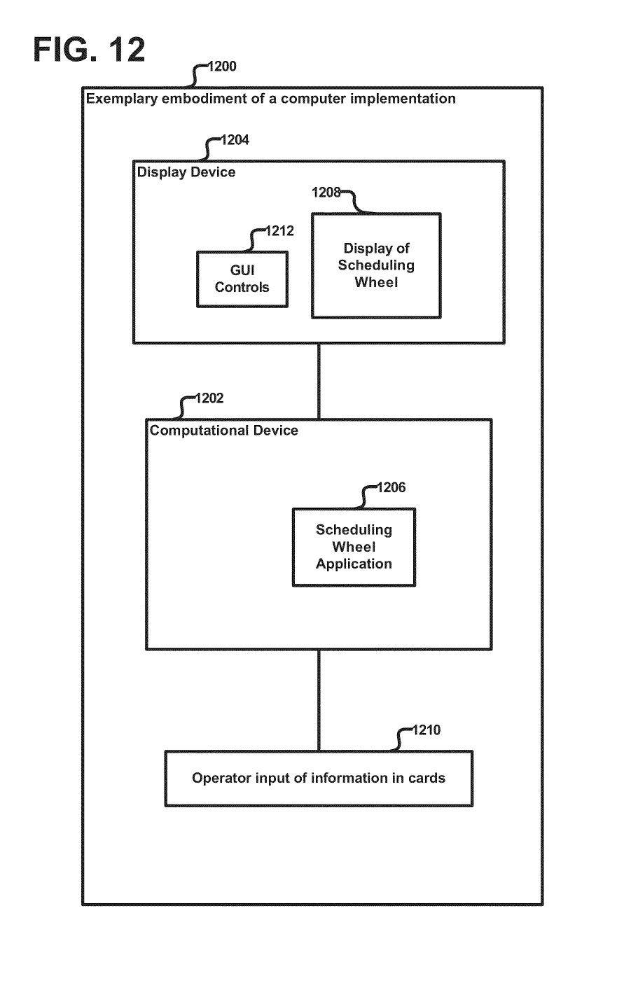

FIG. 12 illustrates a block diagram 1200 of a scheduling wheel implemented in a computational device 1202, in accordance with certain embodiments. The computational device 1202 is coupled to a display device 1204. The computational device 1202 may comprise any suitable computational device may such as a personal computer, a server computer, a mini computer, a mainframe computer, a blade computer, a tablet computer, a touch screen computing device, a telephony device, a cell phone, a mobile computational device, etc., and some computational devices may provide web services or cloud computing services. The display device 1204 may be any suitable display device such as a Liquid Crystal Display (LCD), Light Emitting Diode (LED), Cathode Ray Tube (CRT), touch screen, etc.

The computational device 1202 may include a scheduling wheel application 1206 implemented in software, firmware, hardware or any combination thereof. The scheduling wheel application 1206 may simulate via, execution of a computer program a display 1208 of the scheduling wheel and the operations of the scheduling wheel described in FIGS. 1-11. For example, the operator may input information to be found in cards (reference numeral 1210) to the scheduling wheel application 1206, and may remove cards, or rotate the scheduling wheel by manipulating various controls via a, mouse, track pad, etc., where the controls are displayed as graphical user interface (GUI) controls 1212 on the display device 1204.

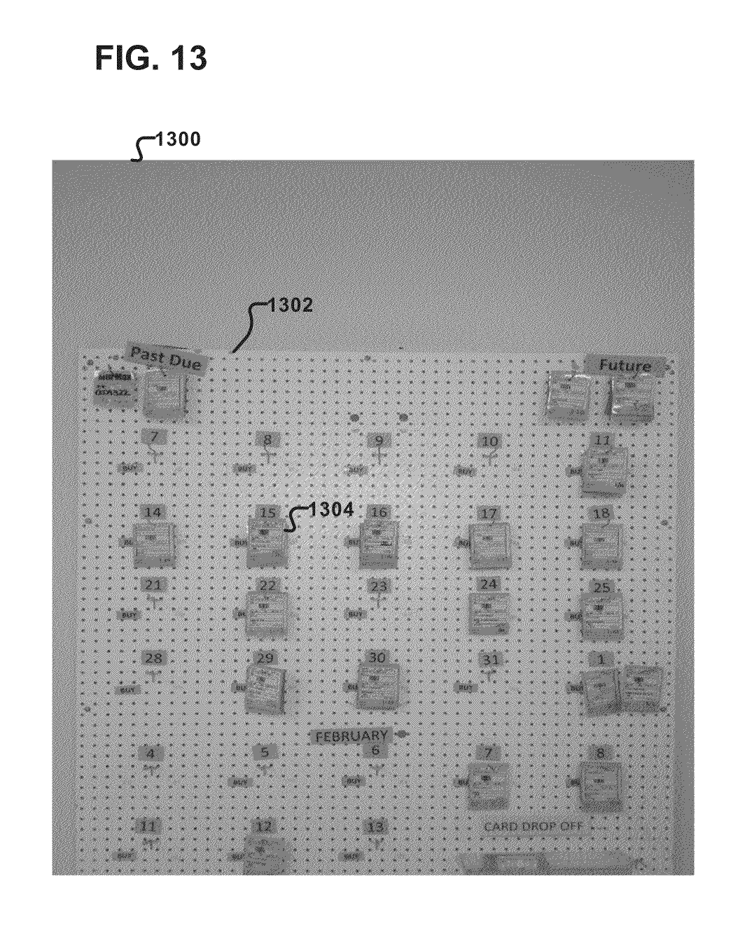

FIG. 13 illustrates a block diagram 1300 of certain mechanisms over which the scheduling wheel is an improvement, in accordance with certain embodiments. In FIG. 13 a monthly calendar 1302 is shown, for each day cards (e.g., cards 1304) are associated based on when the customer order is due for completion. There is no quick visual way for an operator to determine the state of the inventory in such embodiments, unlike embodiments that employ the scheduling wheel.

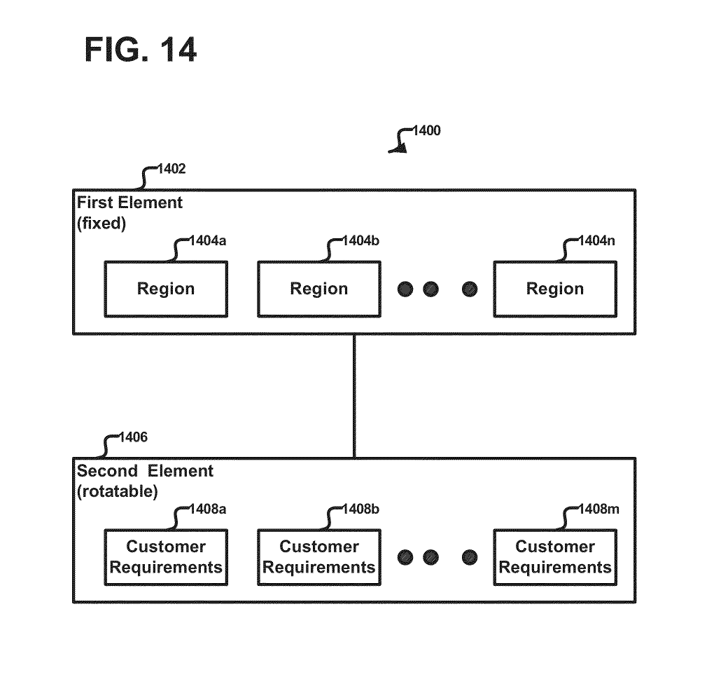

FIG. 14 illustrates an apparatus, in accordance with certain embodiments. The apparatus 1400 comprises a first element 1402 (e.g., the inner wheel) that is fixed, where one or more regions 1404a, 1404b, . . . 1404n (e.g., red, green, blue regions) in the first element 1402 correspond to indications of inventory states. The apparatus 1400 also comprises a second element 1406 (e.g., an outer wheel) that is movable, wherein customer requirements 1408a, 1408b, . . . 1408m (e.g., cards) are stored in the second element, where the one or more regions in the first element are interpreted to determine an inventory state based on the stored customer requirements.

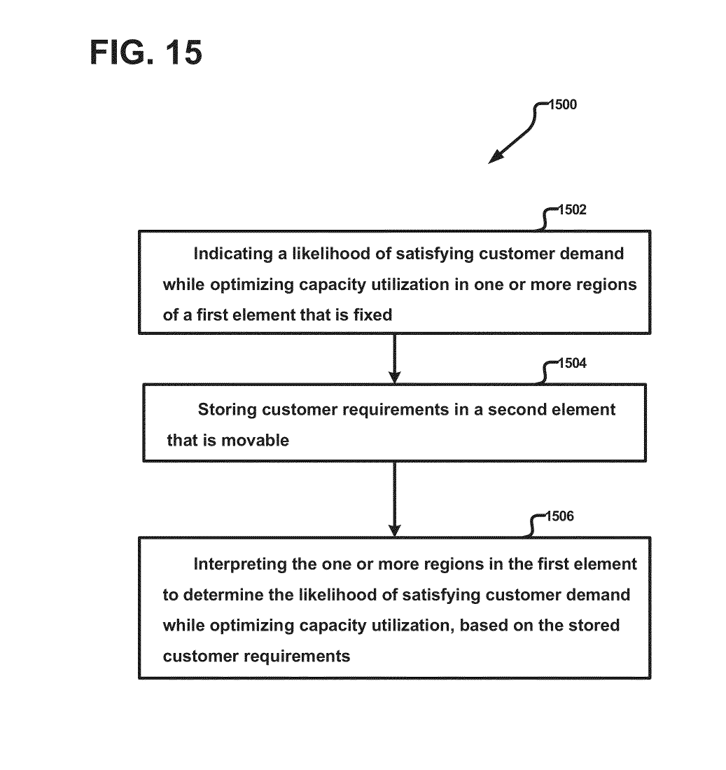

FIG. 15 illustrates a flowchart 1500, in accordance with certain embodiments. The operations shown in flowchart 1500 may be performed by an operator or by a computational device 1502.

Control starts at block 1502 in which a scheduling wheel or other manufactured or displayed apparatus indicates a likelihood of satisfying customer demand while optimizing capacity utilization in one or more regions of a first element that is fixed. Customer requirements are stored (at block 1504) in a second element that is movable. The one or more regions in the first element are interpreted (at block 1506) to determine the likelihood of satisfying customer demand while optimizing capacity utilization, based on the stored customer requirements.

Therefore, FIGS. 1-15 illustrate a visual scheduling tool to display the state of inventory to an operator, such that the operator may take appropriate action to speed up, slow down, or maintain a rate of batch manufacturing of parts in a batch manufacturing environment to optimize capacity utilization.

### Further Details

Certain card management systems may rely on a manual pull and may lack capacity driven information and dynamic approach that adjust to changing customer conditions, e.g. demand increase or decrease, quality, machine or part shortages creating artificial load on a production cell (i.e., batch production environment), etc. In certain system cards may be shuffled daily and information may be dispersed through several different functional groups, and making decision making difficult for determining operator loading in each area. The scheduling wheel takes the pull inputs from planning and toads them on the wheel that acts as a tachometer to determine daily run rate for the cell. This information feeds the operator loading chart to determine standard work play. Based on inputs for the chart (cycle time, lead-time, backlog of work) an operator may determine the probability of taking care of the customer, and the system may provide a leading indicator of when and how many resources to add to a cell to meet customer demand. Certain embodiments may be used to measure machine time or operator time depending on capacity constraint for a particular resource.

### Additional Details of Embodiments

The operations described in the figures may be implemented as a method, apparatus or computer program product using techniques to produce software, firmware, hardware, or any combination thereof. Additionally, certain embodiments may take the form of a computer program product embodied in one or more computer readable storage medium(s) having computer readable program code embodied therein.

A computer readable storage medium may include an electronic, magnetic, optical, electromagnetic, or semiconductor system, apparatus, or device, or any suitable combination of the foregoing. The computer readable storage medium may also comprise an electrical connection having one or more wires, a portable computer diskette or disk, a hard disk, a random access memory (RAM), a read-only memory (ROM), an erasable programmable read-only memory (EPROM or Flash memory), a portable compact disc read-only memory (CD-ROM), an optical storage device, a magnetic storage device, etc. A computer readable storage medium may be any tangible medium that can contain, or store a program for use by or in connection with an instruction execution system, apparatus, or device.

A computer readable signal medium includes a propagated data signal with computer readable program code embodied therein. A computer readable signal medium may be any computer readable medium that is not a computer readable storage medium and that can communicate, propagate, or transport a program for use by or in connection with an instruction execution system, apparatus, or device. The computer readable storage medium is different from the computer readable signal medium.

Computer program code for carrying out operations for aspects of the present invention may be written in any combination of one or more programming languages.

Aspects of the present invention are described below with reference to flowchart illustrations and/or block diagrams of methods, system and computer program products according to certain embodiments At least certain operations that may have been illustrated in the figures show certain events occurring in a certain order. In alternative embodiments, certain operations may be performed in a different order, modified or removed. Additionally, operations may be added to the above described logic and still conform to the described embodiments. Further, operations described herein may occur sequentially or certain operations may be processed in parallel. Yet further, operations may be performed by a single processing unit or by distributed processing units. Computer program instructions can implement the blocks of the flowchart. These computer program instructions may be provided to a processor of a computer for execution.

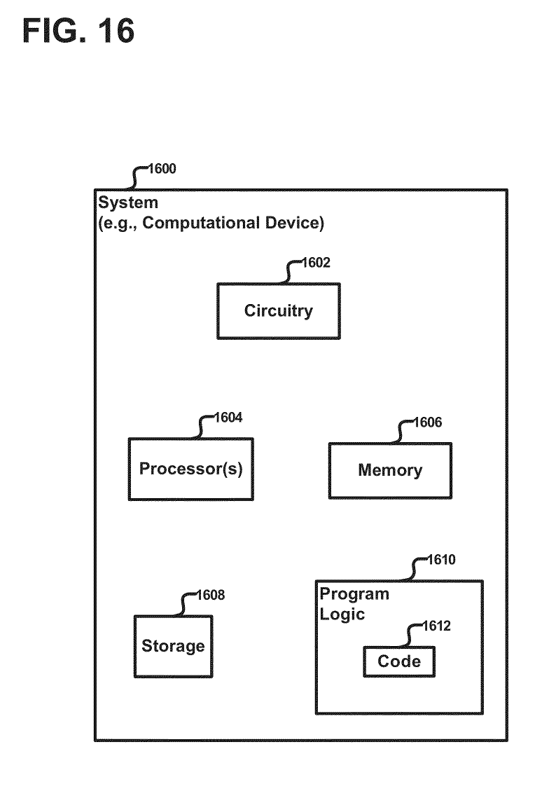

FIG. 16 illustrates a block diagram that shows certain elements that may be included in a computational device 1600, where in the computational device 1600 may be the computational device 1202, in accordance with certain embodiments. The system 1600 may include a circuitry 1602 that may in certain embodiments include at least a processor 1604. The processor 1604 may comprise any suitable processor known in the art, such as, an arithmetic logical unit, a central processing unit, a circuitry that perform operations, hardware that performs instructions of a computer program, a microprocessor, a parallel processor, an array processor, a vector processor, a transistorized central processing unit, a microcontroller, a logic circuitry, etc. Any device that manipulates digital information based on one or more operational instructions or in a predefined manner is an example of the processor 1604. The system 1600 may also include a memory 1606 (e,g., a volatile memory device), and storage 1608. The storage 1608 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1608 may comprise an internal storage device, an attached storage device and/or a network accessible storage device. The system 1600 may include a program logic 1610 including code 1612 that may be loaded into the memory 1606 and executed by the processor 1604 or circuitry 1602. In certain embodiments, the program logic 1610 including code 1612 may be stored in the storage 1608. In certain other embodiments, the program logic 1610 may be implemented in the circuitry 1602. Therefore, while FIG. 16 shows the program logic 1610 separately from the other elements, the program logic 1610 may be implemented in the memory 1606 and/or the circuitry 1602.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is

1. An apparatus, comprising:
a first element that is fixed, wherein one or more regions in the first element correspond to indications of a likelihood of satisfying customer demand while optimizing capacity utilization; and
a second element that is movable, wherein customer requirements are stored in the second element, wherein the one or more regions in the first element are interpreted to determine the likelihood of satisfying customer demand while optimizing capacity utilization, based on the stored customer requirements.

2. The apparatus of claim 1, wherein the customer requirements are included in one or more cards that include order information, and wherein the one or more cards are placed in, or removed from locations in the second element.

3. The apparatus of claim 2, wherein:
the first element is an inner wheel that cannot be rotated; and
the second element is an outer wheel that is rotated, in response to a selected location in the second element being emptied of cards.

4. The apparatus of claim 1, wherein the one or more regions in the first element are color coded to provide indications of inventory states.

5. The apparatus of claim 4, wherein:
a first color coding indicates that there is insufficient inventory; and
a second color coding indicates that there is excessive inventory.

6. The apparatus of claim 5, wherein:
a third color coding indicates that inventory and customer demand are in balance.

7. The apparatus of claim 1, wherein the first element and the second element together comprise a visual scheduling tool.

8. The apparatus of claim 1, wherein the first element and the second element are coupled mechanically, and wherein the first element is physically rotated by an operator.

9. The apparatus of claim 1, wherein a planning chart is used to generate a mapping of cards of the second element to the indications of the likelihood of satisfying customer demand of the first element.

10. A method, comprising:
indicating a likelihood of satisfying customer demand while optimizing capacity utilization, in one or more regions of a first element that is fixed;
storing customer requirements in a second element that is movable; and
interpreting the one or more regions in the first element to determine the likelihood of satisfying customer demand while optimizing capacity utilization, based on the stored customer requirements.

11. The method of claim 10, wherein the customer requirements are included in one or more cards that include order information, and wherein the one or more cards are placed in, or removed from locations in the second element.

12. The method of claim 11, wherein:
the first element is an inner wheel that cannot be rotated; and
the second element is an outer wheel that is rotated, in response to a selected location in the second element being emptied of cards.

13. The method of claim 10, wherein the one or more regions in the first element are color coded to provide the indications of the inventory states.

14. The method of claim 13, wherein:
a first color coding indicates that there is insufficient inventory;
a second color coding indicates that there is excessive inventory.

15. The method of claim 14, wherein:
a third color coding indicates that inventory and customer demand is in balance.

16. The method of claim 10, wherein the first element and the second element are coupled mechanically, and wherein the first element is physically rotated by an operator.

17. The method of claim 10, the method further comprising:
generating, via a planning chart, a mapping of cards of he second element to the indications of the likelihood of satisfying customer demand of the first element.

18. The method of claim 10, wherein the indicating, the storing, and the interpreting are performed via a computational device.

19. A computational system, comprising:
a memory; and
a processor, wherein the processor performs operations, the operations comprising:
indicating a likelihood of satisfying customer demand while optimizing capacity utilization, in one or more regions of a first element that is fixed;
storing customer requirements in a second element that is movable; and
interpreting the one or more regions in the first element to determine the likelihood of satisfying customer demand while optimizing capacity utilization, based on the stored customer requirements.

20. The computational system of claim 19, wherein the customer requirements are included in one or more cards that include order information, and wherein the one or more cards are placed in, or removed from locations in the second element.

21. The computational system of claim 20, wherein:
the first element is an inner wheel that cannot be rotated; and
the second element is an outer wheel that is rotated, in response to a selected location in the second acme being emptied of cards.

22. The computational system of claim 19, wherein the one or more regions in the first element are color coded to provide the indications of the inventory states.

23. A computer readable storage medium, wherein code stored in the computer readable storage medium when executed via a computer causes operations to be executed in a processor, the operations comprising:
indicating a likelihood of satisfying customer demand while optimizing capacity utilization in one or more regions of a first element that is fixed;
storing customer requirements in a second element that is movable; and
interpreting the one or more regions in the first element to determine the likelihood of satisfying customer demand while optimizing capacity utilization, based on the stored customer requirements.
